(19) United States
(12) Patent Application Publication
(10) Pub. No.: US 2016/0253762 A1
(43) Pub. Date: Sep. 1, 2016

(54) A method for a social media mechanism to facilitate collaboration and information exchange for private investment funds

(71) Applicant: Peter MCGRATH, Toronto (CA)

(72) Inventor: Peter McGrath, Toronto (CA)

(21) Appl. No.: 14/762,871

(22) PCT Filed: Jun. 27, 2014
(86) PCT No.: PCT/IB2014/062690

§ 371 Date: Jul. 23, 2015

(30) Foreign Application Priority Data
May 8, 2014 (IB) PCT/IB2014/001225

(51) Int. Cl. G06Q 50/00; G06F 17/30; G06Q 40/06

(52) U.S. Cl. CPC G06Q 50/01; G06Q 40/06; G06F 17/3053; G06F 17/30867

(57) ABSTRACT

Unlike publicly traded securities, current information and documents on private investments are not often in the public domain. Also, a typical private investment has a small existing or potential investor base worldwide. Further, institutional and private investors in private investments rarely publicize or disclose their interest or investments in private investments. In addition, at any given time only a small number of relevant institutional investors or analysts are likely to be interested in buying, selling or diligencing a specific private investment. Anonymously gaining access to such information or finding contacts willing to collaborate on diligence research, buying or selling and analysis of any specific private investment is likely to be onerous if not impossible. Even when an industry participant has an existing business relationship with the relevant business contact, details of the private investments your business connections are currently diligencing, have interest in buying or selling are often held in private confidence.

To ease such barriers and to enhance exchange and collaboration amongst investment professionals, this new invention allows investors to openly share what private investments they are buying, selling, diligencing or following since the platform's tailored privacy settings assures preserved anonymity if so chosen. The invented mechanism facilitates free communication, collaboration on due diligence analysis, buying and selling, access to and the ability to freely share information which may be confidential in nature through the use of social media tools, in a privacy controlled computer network environment.

### BACKGROUND OF INVENTION

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager. “Private Investments”, as used herein and throughout this description, refers to private securities, such as Funds, private equity and private debt that are not publically traded on an exchange and are generally subject to substantial restrictions on transferability.

1. Technical Field

The present invention is related to computer software and tools to facilitate the establishment of due diligence, buying and selling connections for private funds and other privately traded investments for the sake of collaboration and information exchange. The disclosure relates to a financial field combined with social networking, and more specifically relates to a social media based mechanism for facilitating the establishment of due diligence, buying and selling connections for private funds and other private investments for the sake of collaboration and information exchange for and among institutional and private investors.

2. Background Art

Social media has become an important means of communication and networking in this modern age. However its application to business, in some cases, is limited by privacy considerations especially with regard to private investments where participants often prefer to be unidentified. Also, the confidential nature of information relating to private investments necessitates the implementation of a tailored privacy mechanism. Due to confidentiality considerations and the limited number of Private Investment industry participants who are knowledgeable about or are concurrently analyzing a specific Private Investment at any given time, it is very difficult to find and establish connections with other participants who are willing to collaborate. Even where business relationships amongst industry participants pre-exist, it is highly unlikely that industry participants share details on the private investments currently under review or consideration with their network due to privacy considerations. The invention allows users to seamlessly find relevant contacts and collaborate on analysis of private investments and selectively share information, with enhanced privacy controls.

### BRIEF SUMMARY OF THE INVENTION

The invention described in this method allows users to establish due diligence, buying and selling connections for private funds and other privately investments for the sake of collaboration and information exchange. The method enables users to find business-relevant contacts, communicate and exchange any relevant files and information whilst maintaining control over personal identity disclosure and the recipients of any shared content.

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager. “Private Investment”, as used herein and throughout this description, refers to a private security, such as a Fund, private shares and private debt that are not publically traded on an exchange and are generally subject to substantial restrictions on transferability.

### BRIEF DESCRIPTION OF DRAWINGS

FIG. 1 shows simplified view of initial set up required for the method

FIG. 2 shows a simplified view of the system

FIG. 3 and FIG. 4 show flowcharts of the method

### DETAILED DESCRIPTION OF THE INVENTION

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager. “Private Investments”, as used herein and throughout this description, refers to private securities, such as Funds, private equity and private debt that are not publically traded on an exchange and are generally subject to substantial restrictions on transferability.

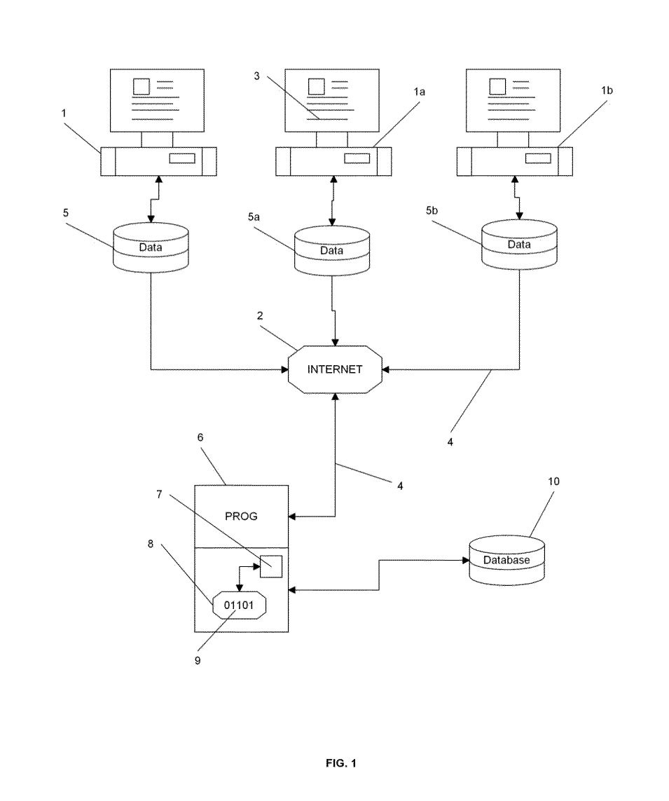

The claims and disclosure herein provide a new method that utilizes a social media mechanism over the internet to facilitate the establishment of due diligence, buying and selling connections for private funds and other privately traded investments for the sake of collaboration and information exchange. The hardware embodiment required and its functionality is show in FIG. 1. The system comprises a database (10) connected to a server (6) which contains a computer-readable medium (8), connected (4) to the internet (2), which in turn is connected either with wires or remotely to a plurality of users' remote terminals (1) which can transmit data and information (3). A specially designed program (9) comprising computer readable statements and instruction, is stored in the computer readable medium (8), written in a language such as Java, Python, ASP.NET, Sal or any other computer programming language is capable, when run by a processor (7), of facilitating real time communication and sharing of files stored in users' databases (5), reorganising and all data into a new database (10) that can be stored in the computer readable medium (8). The database (10) is updated from time to time by storing new data, accessing updated data (5) using internet (2) and internet connection (4).

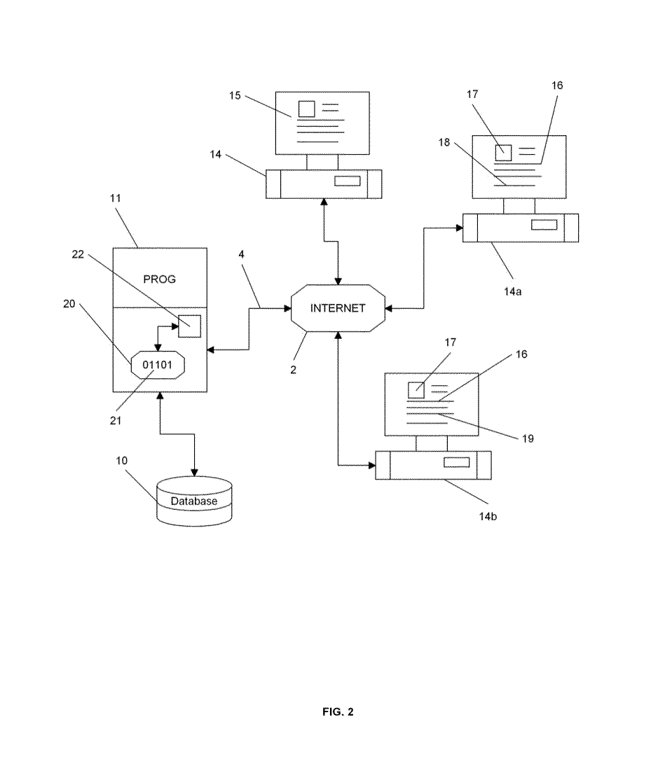

The functionality of the method is shown in FIG. 2. The system comprises a computer-readable medium (20) in a server (11), connected (4) to the internet (20) which in turn is connected either with wires or remotely to a plurality of remote terminals (14). A specially designed software program (21), comprising computer readable statements and instructions, is stored in the computer readable medium (20), written in a language such as Java, Python, ASP.NET, or other computer programming language and is capable, when run by a processor (22) of processing instructions from user terminals (14), processing information from the database (10) that has been created in the initial stage and transmitting information (15) over the internet (2). The program (21) is configured enable it to transmit information for display on a remote terminal (14) including information from the database such as user information, current Private Investment information (17), and receive data and instructions such as input parameters used by the Private Investment Screener to search particular Private Investments or sort Private Investment Screener results (16). The system is designed to receive information and instructions from multiple users and terminals (14, 14a, and 14b).

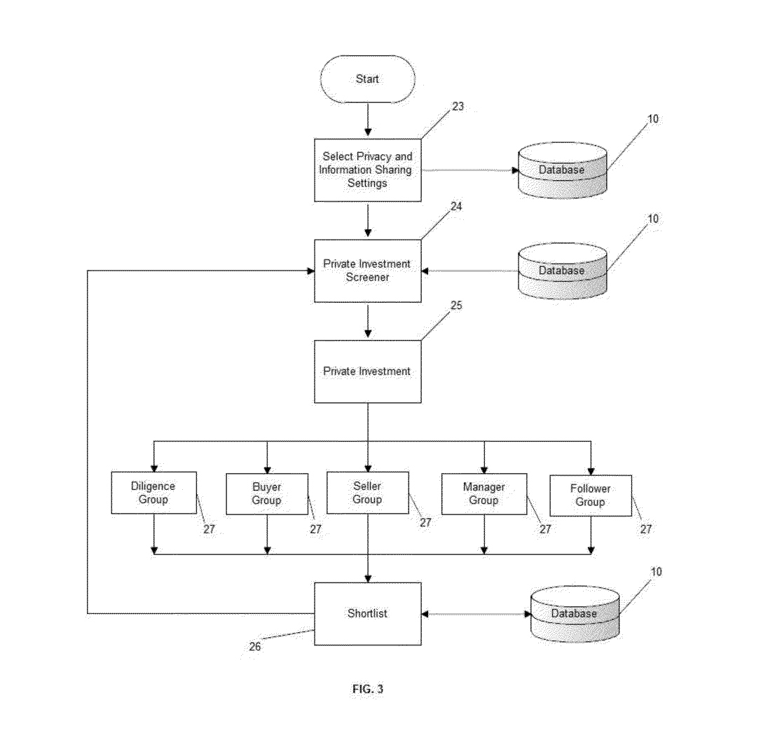

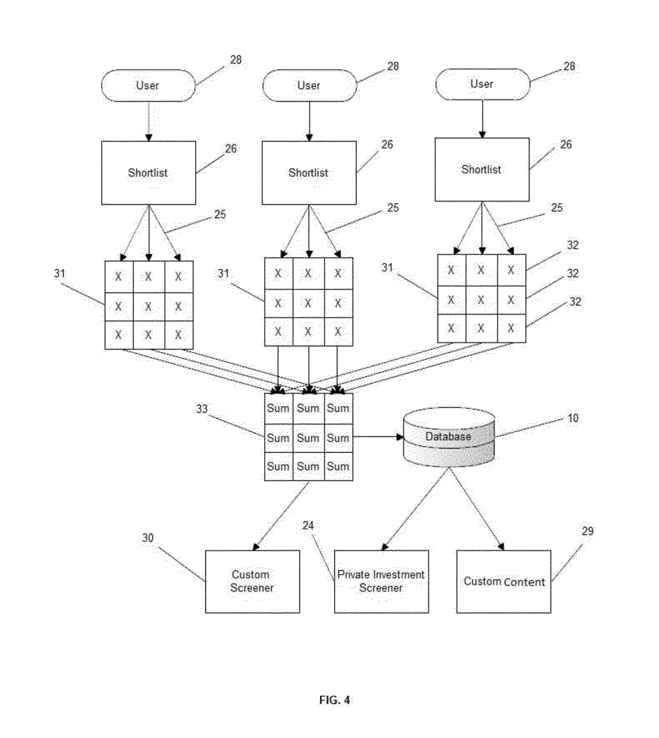

The functionality of the preferred embodiment of the system is shown in FIG. 3 and FIG. 4. First, the database should be created by the specially designed program in the server as described in FIG. 1. Next, the user of the system would connect to the server that can process information from the database as described in FIG. 2. The users will select their privacy and information sharing settings and preferences (23), which will be saved on the database (10). The privacy and information sharing setting and preferences may be changed and updated later by the user under this method. The privacy settings under this method may allow for total anonymity, partial anonymity or a fully transparent personal profile. The user will then use Private Investment Screener (24) to search, screen and select a Private Investment (25) from the database (10). Once the Private Investment is selected, the user will select and join a specific group (27) as related to the specific private investment. The user may select more than one group for each specific investment. The following groups are available in this system: diligence, buyer, seller, manager and follower. The group selection will also allow the user to communicate with other users that are in groups of the same Private Investment (25). Once the Private Investment and group is selected, the Private Investment will be added to the user's shortlist (26) and saved on database (10). The user may then repeat the step of selecting a new Private Investment using the screener (24), selecting the corresponding group (27) and adding the next Private Investment (25) on the shortlist (26). The shortlist will be updated on a continuous basis with new available information from the database (10).

The system will then use information (31) provided by multiple users (28) who have created their own Private Investment shortlists (26) to create a summary data (33) and save it on database (10). The information (31) on the shortlist (26) will have information on each Private Investment (25) and the user's group selections (32) for each Private Investment (25). The summary data (33) then will be used in the custom screener (30) and when coupled with information available on the database (10) to produce Custom Content (29) and to improve the Private Investment Screener (24) by allowing it to provide suggestions to the user.

The custom screener (30) will allow the person to search for users from each group for each specific Private Investment and communicate with them by sending messages or attachments to the whole group or to a specific member. Select information about each user and their identity will appear in each group based on how each user has set their privacy settings. The system may further allow the user to add any number of other users from the specific group for each specific Private Investment to their personal contact lists.

The system will produce Custom Content (29) that will allow the software application to produce a list of buyers, sellers, diligencers, managers and followers for each specific Private Investment. The Custom Content (29) would also allow the software application to rank and measure the level of buying, selling, diligencing and following of Private Investments based on an analysis of the number of users that identify themselves as following, diligencing, buying or selling specific Private Investments, and generate corresponding reports and rankings.

The Private Investment Screener (24) will benefit users (28) by suggesting Private Investments based on the selections of other users that are their contacts or that have the same Private Investments on their shortlists.

The method may be extended further by allowing the system to suggest new contacts to a user based on an analysis of users' shortlist of Private Investments.

The method may be extended further by allowing the system to suggest new contacts to a user based on each user's respective geography and mutual contacts.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A computer-implemented method executed by at least one processor for a social media mechanism that allows users to establish due diligence, buying and selling connections for private funds and other privately traded investments for the purpose of collaboration and information exchange. The method comprising the steps of:
creating a database of the universe of private investment funds and other private investments;
allowing users to screen and filter the directory of private investments by any combination of variables such as geography, strategy, type, size, recent activity, rankings and ratings;
allowing users to follow and receive ongoing updates, communication, user activity and news relating to specific private investments;
allowing users to classify themselves as a member of the due diligence, manager, seller, or buyer groups for specific private investments;
allowing a user to privately message and communicate with other users or groups thereof, identified only by their username or alternatively by their real name depending on the user's privacy settings;
allowing sharing of information and files with other users or groups thereof, identified only by their username or alternatively by their real name depending on the user's privacy settings;

2. The method of claim 1 wherein the step of allowing users to express interest in specific private investments and further classify themselves as a member of the buyer, manager, seller or diligence groups comprises the steps of:
creating a database of the universe of private investment funds and other private investments; allowing users to use a filtering and screening tool to search or identify specific Private Investments;
allowing potential institutional investors to express interest in private investments of choice;
allowing users to further classify themselves as a member of the buyer, manager, seller or diligence groups for each Private Investment for which interest has been indicated.

3. The method of claim 1 wherein the step of allowing users to privately message and communicate with other users or a group of users that follow, manage, buy or sell a specific private investment comprises the steps of:
generating lists of followers, sellers, buyers, diligence contacts and managers for each specific private investment;
allowing users on the lists of followers, sellers, buyers, diligence contacts and managers to be only identified by their username or alternatively by their real name depending on the user's privacy settings
allowing users to privately message other users, or specific groups of users, by their classification of sellers, buyers, managers or diligence contacts of specific private investments.
allowing users to select what digital files and content will be shared or can be re-shared with other users or groups.

4. The method of claim 1 wherein the step of allowing a user to privately message and communicate with other users or groups thereof, identified only by their username or alternatively by their real name depending on the user's privacy settings comprises the steps of:
allowing users to choose to be identified only by their username or alternatively by their real name depending on the user's privacy settings;
having privacy settings based on two users agreeing or having been invited to be one another's ‘contact’ on the social network;
having privacy settings based on whether a user will share the funds they follow, manage, buy, sell or diligence with all user, users they have invited to be their contact, their contacts or no users at all;

5. The method of claim 1 further comprising the step of allowing users to search and filter users based on the private investments they follow, manage, buy, sell or diligence.

6. The method of claim 1 further comprising the step of allowing the system to make accessible and create lists of users that have joined the diligence, buyer, seller, manager or follower groups for specific private investments.

7. The method of claim 1 further comprising the step of producing reports and rankings of private investments based on an analysis of the number of users that join the diligence, buyer, seller, manager or follower groups for each specific private investment.

8. The method may be extended further by allowing users to screen and filter the directory and sort and rank the results based on the number of followers, buyers, sellers, managers and diligence contacts for each fund.

9. The method may be extended further by allowing the system to suggest new contacts to a user based on private investments the user mutually follow, buy, sell or diligence with others.

10. The method may be extended further by allowing users to search and filter users based on the private investments they follow, buy, sell or diligence.
